(19) United States
(12) Patent Application Publication
(10) Pub. No.: US 2010/0183837 A1
(43) Pub. Date: Jul. 22, 2010

(54) USE OF A POLYAMIDE BASED COMPOSITION FOR FLEXIBLE PIPES FOR CONVEYING CRUDE OIL OR GAS AND FLEXIBLE PIPE USING SUCH COMPOSITION

(75) Inventors: Gilles Hochstetter, Bernay (FR); Thomas Fine, Lyon (FR); Patrick Dang, Saint-Leger-De-Rotes (FR); Lionel Hugon, Menneval (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/529,744

(22) PCT Filed: Mar. 7, 2008
(86) PCT No.: PCT/FR08/50389

§ 371 Date: Mar. 16, 2010

Related U.S. Application Data
(60) Provisional application No. 60/914,195, filed on Apr. 26, 2007.

(30) Foreign Application Priority Data
Mar. 7, 2007 (FR) 07.53687

(51) Int. Cl. F16L 11/14; B32B 1/08

(52) U.S. Cl. 428/36.91; 138/139; 428/36.9; 138/143

(57) ABSTRACT

The invention relates to the use of a composition that contains from 70 to 91 wt % of at least one semi-crystalline polyamide, from 5 to 25 wt % of a polyolefin having an epoxy, anhydride or acid function introduced by grafting or copolymerization, and from 4 to 20 wt % of a plasticizer in the production of flexible pipes used in the exploitation of crude oil or gas deposits under the sea that comprises at least one layer obtained from such a composition.

The invention relates to the use of a polyamide-based composition for manufacturing flexible pipes intended for transporting oil or gas, in particular for manufacturing flexible pipes used in the exploitation of offshore oil or gas deposits.

The invention also relates to a flexible pipe intended for transporting oil or gas, this pipe comprising at least one layer obtained from the aforementioned polyamide-based composition.

The exploitation of oil reserves located offshore subjects the materials used to extreme conditions, and in particular the pipes connecting the various devices around the platform and transporting the hydrocarbons extracted, which are generally conveyed at high temperature (around 135° C.) and at high pressure (for example, 700 bar).

During the operation of the installations, the severe problems of mechanical, thermal and chemical resistance of the materials used are therefore encountered. Such pipes must, in particular, be resistant to hot oil, to gas, to water and to mixtures of at least two of these products over periods which may stretch to 20 years.

Conventionally, these pipes comprise a permeable metallic inner layer formed from an extruded metal strip wound in a helix such as an interlocked strip. This metallic inner layer, which gives shape to the pipe, is coated, in general by extrusion, with a polymer layer intended to confer impermeability. Other protective and/or reinforcing layers such as plies of metal fibres and rubbers may also be placed around the impermeable polymer layer.

For operating temperatures below 40° C., the polymer is HDPE (high density polyethylene). For temperatures between 40° C. and 90° C., a polyamide is used, and for temperatures above 90° C., PVDF (polyvinylidene fluoride) is used.

On account of the high cost of PVDF, and despite the implication of higher temperatures than those recommended, the choice of polymer has focussed on polyamides, such as PA-11 and PA-12, which are well known for their good thermal behaviour, their chemical resistance, especially to solvents, their resistance to adverse weather and to radiation, their impermeability to gases and liquids and their electrical insulation quality.

These polyamides are already currently used for manufacturing pipes intended for transporting hydrocarbons extracted from oil reserves located offshore and onshore, however, they have the disadvantage of ageing too rapidly.

To overcome this disadvantage and therefore to improve the ageing resistance of these polyamide-based pipes, document US 2003/0220449, in the name of the Applicant, proposes a composition comprising:
from 70 to 96% by weight of at least one polyamide chosen from PA-11, PA-12, aliphatic polyamides resulting from the condensation of an aliphatic diamine having from 6 to 12 carbon atoms with an aliphatic diacid having from 9 to 12 carbon atoms and PA-11/12 copolyamides having either more than 90% of PA-11 units or more than 90% of PA-12 units;
from 4 to 10% of a plasticizer; and
from 0 to 25% of an elastomer chosen from nitrile butadiene rubber (NBR) and hydrogenated nitrile butadiene rubber (H-NBR), the sum of the amount of plasticizer and the amount of elastomer being between 4 and 30%.

The use of an NBR or H-NBR type elastomer in the compositions described in document US 2003/0220449 has several advantages over the prior compositions solely based on polyamide and plasticizer.

In particular, the introduction of one or other of these elastomers makes it possible to significantly increase the ageing resistance of flexible pipes comprising such a layer, especially by limiting the plasticizer weight content.

However, NBR and H-NBR elastomers are expensive. This economic aspect inevitably has an impact on the overall cost of compositions containing such elastomers, despite the significant reduction in the amount of plasticizer.

Furthermore, these NBR and H-NBR elastomers are sold in the form of balls or chips. This presentation therefore imposes, in order to prepare the composition, the use of a preliminary step that consists in converting, for example by grinding, these balls or chips into a more suitable form, in order to subject them to a subsequent compounding step, especially using an extruder.

The use of these elastomers therefore imposes an additional constraint on the process for preparing the thermoplastic composition, which requires additional equipment and at least one additional conversion step. Such modifications also add a cost premium to that already created by the NBR or H-NBR raw material.

The present invention therefore relates to the use of a polyamide-based composition for manufacturing flexible pipes intended for transporting oil or gas, especially in the offshore field, this composition having at least the same advantages as those obtained by using the composition described in document US 2003/0220449, in particular the improvement in ageing resistance of the flexible pipes from the prior art, but also overcoming at least one of the economic disadvantages identified, namely the choice of a less costly raw material and/or not requiring an additional, inevitably costly, industrial processing step.

According to the invention, the objective is achieved by the use, for manufacturing flexible pipes intended for transporting oil or gas, and more particularly for manufacturing flexible pipes used in the exploitation of offshore oil or gas deposits, of a composition comprising:
from 70 to 91% by weight of at least one semi-crystalline polyamide having an average number of carbon atoms per nitrogen atom, denoted by Nc, greater than or equal to 7.5, advantageously between 9 and 18 and preferably between 10 and 18;
from 5 to 25% by weight of a functionalized polyolefin, that is to say of a polyolefin comprising an epoxy, anhydride or acid functional group, introduced by grafting or by copolymerization; and
from 4 to 20% by weight of a plasticizer.

The expression “semicrystalline polyamide” covers homo-polyamides and copolyamides which have both a glass transition temperature T_{g} and a melting temperature Tₘ.

The expression “semicrystalline polyamides” is directed more particularly to aliphatic homopolyamides resulting from the condensation:
of a lactam;
of an aliphatic α,ω-aminocarboxylic acid;
of an aliphatic diamine and an aliphatic diacid.

Among the semicrystalline polyamides, mention may especially be made, by way of example and non-limitingly, of the following polyamides: PA-9, PA-11, PA-12, PA-6,12 and PA-10,10.

The expression “semicrystalline polyamides” is also directed to the semiaromatic homopolyamides that result from the condensation:
of an aliphatic diamine and an aromatic diacid, such as terephthalic acid (T) and isophthalic acid (I). The polyamides obtained are in this case commonly referred to as “polyphthalamides” or PPAs;
of an aromatic diamine, such as xylylenediamine, and more particularly metaxylylenediamine (MXD), and an aliphatic diacid.

Thus, non-limitingly, mention may be made of the polyamide PA-MXD, 10.

As indicated previously, the expression “semicrystalline polyamides” also covers the copolyamides which result from the condensation of at least two of the groups of compounds listed above for obtaining homopolyamides.

Thus, the copolyamides cover more particularly the products of condensation:
of at least two lactams;
of at least two aliphatic α,ω-aminocarboxylic acids;
of at least one lactam and of at least one aliphatic α,ω-aminocarboxylic acid;
of at least two diamines and at least two diacids;
of at least one lactam with at least one diamine and at least one diacid;
of at least one aliphatic α,ω-aminocarboxylic acid with at least one diamine and at least one diacid,
   the diamine(s) and the diacid(s) possibly being, independently of one another, aliphatic, cycloaliphatic or aromatic.

Among the copolyamides, mention may especially be made of the copolyamide PA-11/10,T and the copolyamide PA-12/10,T.

The semicrystalline polyamide, whether it is an aliphatic, cycloaliphatic or aromatic homopolyamide, or else a copolyamide, has a number of carbon atoms per nitrogen atom that is greater than 7.5, advantageously between 9 and 18 and preferably between 10 and 18.

In the case of a homopolyamide of PA-X,Y type, the number of carbon atoms per nitrogen atom is the average of the X unit and of the Y unit.

In the case of a copolyamide, the number of carbons per nitrogen is calculated according to the same principle. The calculation is carried out on the molar proportions of the various amide units.

The composition used within the context of the present invention comprises at least one semicrystalline polyamide, that is to say that it may comprise a mixture of two or more of the semicrystalline polyamides from the crystalline polyamides corresponding to the definition given above.

In particular, it is advantageously possible to envisage the use of a composition comprising copolyamide PA-11/10,T and/or copolyamide PA-12/10,T, as a mixture with PA-11 and/or PA-12.

Advantageously, the invention targets the use of a composition comprising:
from 70 to 91% by weight of at least one polyamide chosen from PA-11, PA-12, aliphatic polyamides resulting from the condensation of an aliphatic diamine having from 6 to 12 carbon atoms with an aliphatic diacid having from 9 to 12 carbon atoms and PA-11/12 copolyamides having either more than 90% of PA-11 units or more than 90% of PA-12 units;
from 5 to 25% by weight of a functionalized polyolefin; and
from 4 to 20% by weight of a plasticizer.

In an advantageous version of the invention, the polyolefin is an elastomeric ethylene copolymer.

Preferably, this elastomeric ethylene copolymer is chosen from an ethylene/propylene copolymer (EPR), an ethylene/butylene copolymer and an ethylene/alkyl (meth)acrylate copolymer.

In terms of cost, the functionalized polyolefins, especially elastomeric ethylene-based copolymers, such as those mentioned above, and in particular EPR, in addition to being less costly than the NBR or H-NBR elastomer, are easy to use. They do not require a prior forming step and may be compounded directly.

The present invention also relates to a flexible pipe intended for transporting oil or gas, in particular a flexible pipe intended to be used for the exploitation of offshore oil or gas deposits.

According to the invention, the flexible pipe comprises at least one layer obtained from a composition comprising:
from 70 to 91% by weight of at least one semi-crystalline polyamide having an average number of carbon atoms per nitrogen atom, denoted by Nc, greater than or equal to 7.5, advantageously between 9 and 18 and preferably between 10 and 18;
from 5 to 25% by weight of a polyolefin comprising an epoxy, anhydride or acid functional group, introduced by grafting or by copolymerization, the polyolefin advantageously being an elastomeric ethylene copolymer, this elastomeric ethylene copolymer being preferably chosen from an ethylene/propylene copolymer (EPR), an ethylene/butylene copolymer and an ethylene/alkyl (meth)acrylate copolymer; and
from 4 to 20% by weight, preferably from 5 to 13% by weight, of a plasticizer.

Reference will be made to what has been described previously for the semicrystalline polyamide.

Advantageously, the flexible pipe comprises at least one layer obtained from a composition comprising:
from 70 to 91% by weight of at least one polyamide chosen from PA-11, PA-12, aliphatic polyamides resulting from the condensation of an aliphatic diamine having from 6 to 12 carbon atoms with an aliphatic diacid having from 9 to 12 carbon atoms and PA-11/12 copolyaxnides having either more than 90% of PA-11 units or more than 90% of EA-12 units;
from 5 to 25% by weight of a polyolefin comprising an epoxy, anhydride or acid functional group, introduced by grafting or by copolymerization, the polyolefin advantageously being an elastomeric ethylene copolymer, this elastomeric ethylene copolymer being preferably chosen from an ethylene/propylene copolymer (EPR), an ethylene/butylene copolymer and an ethylene/alkyl (meth)acrylate copolymer; and
from 4 to 20% by weight, preferably from 5 to 13% by weight, of a plasticizer.

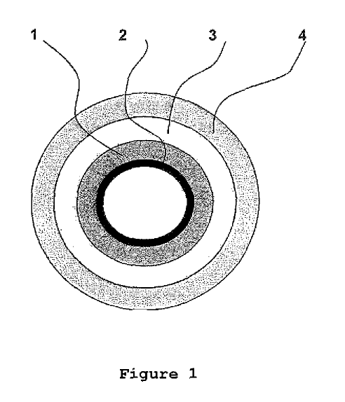

The description that follows is given by way of non-limiting illustration of the invention and is made, in part, with reference to FIG. 1 which is a schematic cross-sectional representation of an exemplary embodiment of a flexible pipe according to the present invention.

The present invention therefore relates to the use, for manufacturing flexible pipes intended for transporting oil or gas, of a specific composition, this composition comprising:
from 70 to 91% by weight of at least one semicrystalline polyamide having an average number of carbon atoms per nitrogen atom, denoted by Nc, greater than or equal to 7.5, advantageously between 9 and 18 and preferably between 10 and 18, this semicrystalline polyamide being advantageously chosen from PA-11, PA-12, aliphatic polyamides resulting from the condensation of an aliphatic diamine having from 6 to 12 carbon atoms with an aliphatic diacid having from 9 to 12 carbon atoms and PA-11/12 copolyamides having either more than 90% of PA-11 units or more than 90% of PA-12 units,
from 5 to 25% by weight of an elastomeric ethylene copolymer comprising an epoxy, anhydride or acid functional group, introduced by grafting or by copolymerization; and
from 4 to 20% by weight of a plasticizer.

The polyamide used within the scope of the present invention can have, in particular, a number-average molecular weight M̅ₙ that is in general greater than or equal to 25 000 and advantageously between 40 000 and 100 000. Its weight-average molecular weight M̅_{w} is in general greater than 40 000 and advantageously between 50 000 and 100 000; it can be as much as 200 000. Its inherent viscosity (measured at 20° C. for a sample of 5×10⁻³ g/cm³ of meta-cresol) is in general greater than 0.7, preferably greater than 1.2.

As examples of aliphatic polyamides resulting from the condensation of an aliphatic diamine having from 6 to 12 carbon atoms with an aliphatic diacid having from 9 to 12 carbon atoms, mention may be made of:
PA-6-12 resulting from the condensation of hexamethylenediamine with 1,12-dodecanedioic acid;
PA-9-12 resulting from the condensation of the C₉ diamine with 1,12-dodecanedioic acid;
PA-10-10 resulting from the condensation of the C₁₀ diamine with 1,10-decanedioic acid; and
PA-10-12 resulting from the condensation of the C₁₀ diamine with 1,12-dodecanedoic acid.

The PA-11/12 copolyamides, having either more than 90% of PA-11 units or more than 90% of PA-12 units, result from the condensation of 1-aminoundecanoic acid with lauryllactam (or the C₁₂ α,ω-amino acid).

It would not be outside the scope of the invention to use a blend of two or more semicrystalline polyamides and especially the polyamides and copolyamides described above.

The polyamide is preferably PA-11 or PA-12.

The composition used within the scope of the present invention comprises from 70 to 91% by weight of at least one semicrystalline polyamide, the polyamide being advantageously chosen from those mentioned above.

More preferentially, this polyamide(s) content is between 75 to 87% by weight of the total weight of the composition.

Advantageously, the polyamide contains a catalyst, which may be organic or mineral, and which is added in the course of the polycondensation. Preferably, this catalyst is chosen from phosphoric acid and hypophosphoric acid.

According to one advantageous version of the invention, the amount of catalyst represents up to 3000 ppm, and preferably between 50 and 1000 ppm, relative to the amount of polyamide(s).

The term “polyolefin” is understood to mean a polymer comprising olefin units such as, for example, units of ethylene, propylene, butene, octene or any other α-olefin.

By way of example, mention may be made of:
polyethylenes such as LDPEs, HDPEs, LLDPEs or VLDPEs, polypropylene or else metallocene polyethylenes;
ethylene copolymers such as ethylene/propylene copolymers, ethylene/propylene/diene terpolymers; and
copolymers of ethylene with at least one product chosen from the salts or esters of unsaturated carboxylic acids and the vinyl esters of saturated carboxylic acids.

In one particularly advantageous version of the invention, the polyolefin is an elastomeric ethylene copolymer.

One such elastomeric ethylene copolymer is a compound obtained from at least two different monomers of which at least one is an ethylene monomer.

Preferably, this elastomeric ethylene copolymer is chosen from an ethylene/propylene copolymer (EPR), an ethylene/butylene copolymer and an ethylene/alkyl (meth)acrylate copolymer.

The ethylene/propylene copolymer (EPR) is a well-known elastomeric copolymer, obtained from ethylene and propylene monomers. EPR, or EPM, is especially described in the work Ullmann's Encyclopaedia of Industrial Chemistry, 5^{th} edition, Vol. A 23, pages 282 to 288, the content being incorporated into the present application.

The ethylene/butylene copolymer is obtained from ethylene and 1-butene monomers.

The ethylene/alkyl(meth)acrylate copolymer is obtained by radical polymerization of ethylene and alkyl (meth)acrylate. The alkyl(meth)acrylate is preferably chosen from methyl(meth)acrylate, ethyl acrylate, n-butyl acrylate, isobutyl acrylate, octyl acrylate and 2-ethylhexyl acrylate.

The polyolefin used within the scope of the present invention is functionalized in the sense that it comprises at least one epoxy, anhydride or acid functional group, this functional group being introduced by grafting or by copolymerization.

The functionalized polyolefin may especially be chosen from functionalized ethylene/α-olefin copolymers and functionalized ethylene/alkyl(meth)acrylate copolymers.

The functionalized polyolefin may also be chosen from:
copolymers of ethylene with an unsaturated epoxide and optionally with an ester or a salt of an unsaturated carboxylic acid or of a vinyl ester of a saturated carboxylic acid. These are, for example, ethylene/vinyl acetate/glycidyl(meth)acrylate copolymers or ethylene/alkyl(meth)acrylate/glycidyl(meth)acrylate copolymers; and
copolymers of ethylene with an unsaturated carboxylic acid anhydride and/or with an unsaturated carboxylic acid that may be partially neutralized by a metal (Zn) or an alkali metal (Li) and optionally of an ester of an unsaturated carboxylic acid or of a vinyl ester of a saturated carboxylic acid. These are, for example, ethylene/vinyl acetate/maleic anhydride copolymers, ethylene/alkyl(meth)acrylate/maleic anhydride copolymers or else ethylene/Zn or Li (meth)acrylate/maleic anhydride copolymers.

The density of the functionalized polyolefin may advantageously be between 0.86 and 0.965.

Advantageously, the polyolefin is functionalized by a carboxylic acid anhydride.

More preferentially, the functionalized polyolefin is chosen from a maleic anhydride-grafted ethylene/propylene copolymer (EPR), a maleic anhydride-grafted ethylene/butylene copolymer and an ethylene/alkyl (meth)acrylate copolymer comprising a maleic anhydride functional group.

By way of example of an ethylene/alkyl(meth)acrylate copolymer comprising a maleic anhydride functional group, mention may be made of ethylene, alkyl acrylate and maleic anhydride terpolymers, especially those sold by the Applicant under the trade mark LOTADER®.

The composition used within the scope of the present invention comprises from 5 to 25% by weight, advantageously from 8 to 15% and preferably from 8 to 12% by weight of at least one functionalized polyolefin.

It would not be outside the scope of the invention if this composition comprised a blend of at least one functionalized polyolefin and at least one unfunctionalized polyolefin, that is to say which does not comprise any functional groups.

It is thus envisionable to introduce up to 80% by weight of unfunctionalized polyolefin(s) into this blend of at least one functionalized polyolefin and at least one unfunctionalized polyolefin.

By way of example, this may correspond to a blend between an ethylene/alkyl(meth)acrylate copolymer comprising a maleic anhydride functional group, introduced by grafting or copolymerization, and an ethylene/alkyl(meth)acrylate copolymer.

More preferentially, this content of functionalized polyolefin(s) comprising where appropriate one or more unfunctionalized polyolefins, is between 8 to 12% by weight of the total weight of the composition.

The plasticizer is chosen from benzenesulphonamide derivatives, such as N-butylbenzenesulphonamide (BBSA); ethyltoluenesulphonamide or N-cyclohexyltoluene-sulphonamide; esters of hydroxybenzoic acids, such as 2-ethylhexyl para-hydroxybenzoate and 2-decylhexyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

It would not be outside the scope of the invention to use a mixture of plasticizers.

The particularly preferred plasticizer is N-butylbenzenesulphonamide (BBSA).

The plasticizer may be introduced into the polyamide during the polycondensation or subsequently.

The composition used within the scope of the present invention comprises from 4 to 20% by weight of at least one plasticizer from those mentioned above.

More preferentially, this plasticizer(s) content is between 5 and 13% by weight of the total weight of the composition.

The composition may, in addition, comprise at least one additive chosen from impact modifiers, these impact modifiers preferably not corresponding to the definition of the functionalized polyolefins described above, dyes, pigments, brighteners, antioxidants and UV stabilizers.

These products are known in themselves and commonly used in polyamide-based compositions.

Among the impact modifiers, mention may especially be made of inorganic or organic fillers, rubbers and core-shell compounds as described in the document “Plastics Additives: An A-Z Reference, published in 1998 by Chapman & Hall, London; Impacts modifiers: (2) Modifiers for engineering thermoplastics, C. A. Cruz, Jr.” or the document “Antec, 2002 Plastics: Annual Technical Conference, Volume 3: Special Areas—Additives and Modifiers—, Novel acrylic, weatherable impact modifiers with excellent low temperature impact performance, Claude Granel & Michael Tran”. As core-shell compounds that can be used, mention may be made of those that have an elastomeric core made of a crosslinked polymer based on butyl acrylate and that have a hard shell made of poly(methyl methacrylate).

The amount of these additives may represent up to 5% by weight, and advantageously between 0.5 and 2% by weight, of the total weight of the composition comprising the polyamide(s), the plasticizer and the functional polyolefin, in particular the functionalized elastomeric ethylene polymer.

In one advantageous version of the invention, the composition does not comprise a polyimide thickener of the type of compound (D) described in paragraph [0038] of document US 2002/0147272.

The composition used within the scope of the present invention is prepared by melt-blending the various constituents in any mixing device, preferably an extruder.

The composition is usually recovered in the form of granules.

The present invention will now be illustrated by examples of various compositions whose use is the subject of the present invention and also by various flexible pipe structures, also in accordance with the subject of the present invention.

### Materials Used

PA-11: polyamide-11 having a density of 1.030 g/cm³ and an ISO inherent viscosity of 1.35 dL/g, sold under the reference BESNO by Arkema France;
BBSA: N-butylbenzenesulphonamide (plasticizer) sold by Proviron;
Stab: system of antioxidant and UV stabilizing additives;
EXXELOR VA 1803: ethylene/propylene copolymer functionalized by maleic anhydride having a density of 0.86 g/cm³ and an MFI (10 kg/230° C.) of 22, sold by Exxon;
EXXELOR VA 1801: ethylene/propylene copolymer functionalized by maleic anhydride having a density of 0.87 g/cm³ and an MFI (10 kg/230° C.) of 9, sold by Exxon; and
NIPOL CGX 1072: acrylonitrile (19%)/butadiene NBR random copolymer having a density of 0.98 g/cm³ and a Mooney viscosity of 45±5, ML (1+4) at 100° C., sold by Zeon France.

### Preparation of the Compositions

Within the scope of the trials numbered 1 to 5, five different compositions were prepared.

In trial 2, corresponding to a composition of the prior art comprising NBR, this NBR was ground beforehand after cooling with liquid nitrogen in a “LANCELIN® crusher (pre-grinding on a 16 mm mesh, then reworking on a 6 mm mesh) in the presence of an anti-caking agent (calcium stearate).

When using elastomeric ethylene copolymers, this prior step was not needed as these copolymers are all available in granule form.

The products were compounded in a WERNER® 40 (L/D=40) co-rotating twin-screw extruder. This extruder comprises 10 zones numbered from F1 to F9 and the die. The feed zone F1 was not heated and a 270° C. flat temperature profile was adopted for all the other zones.

The polyamide, the elastomeric copolymer and the Stab additive were introduced into zone F1 in the form of a dry blend by means of two separate weigh feeders.

The plasticizer (BBSA) was introduced in zone F6-7 by a metering pump. Vacuum degassing relative to 360 mm Hg was carried out in zone F4.

The die exit extrusion rate was 80 kg/h for a screw rotation speed of 300 rpm (revolutions per minute). The rod was granulated after cooling in a water tank. The granules from the various trials 1 to 5 were then dried at 80° C. for hours and packed in sealed bags after checking the moisture contents (% water less than or equal to 0.08%).

Given in Table 1 below is information relating to the various compounds and their respective weight percentages in the compositions of trials 1 to 5, and also relating to certain parameters obtained during the extrusion (head temperatures T, head pressures P, torque). The vacuum was set so that the head pressure was constant from one trial to another and was between 20 and 24 bar.

TABLE 1

| Trial | 1 | 2 | 3 | 4 | 5 |
|---|---|---|---|---|---|
| PA-11 (%) | 86.8 | 83.4 | 79.4 | 83.4 | 83.4 |
| BBSA (%) | 12 | 6 | 6 | 6 | 6 |
| NBR (%) | 0 | 10 | 0 | 0 | 0 |
| EXXELOR VA1803 (%) | 0 | 0 | 14 | 10 | 0 |
| EXXELOR VA1801 (%) | 0 | 0 | 0 | 0 | 10 |
| Stab (%) | 1.2 | 0.6 | 0.6 | 0.6 | 0,6 |
| Head T (° C.) | 274 | 277 | 275 | 275 | 277 |
| Head P (bar) | 20 | 20 | 23 | 23 | 23 |
| Torque (%) | 70 | 81 | 89 | 77 | 80 |

The plasticizer content was reduced in trial 2 to 5 relative to that of trial 1 in order to maintain a comparable level of tensile modulus for all of trials 1 to 5.

The granules from trials 1 to 5 were then extruded in the form of samples, which were either in the form of strips, or in the form of tubes.

6-mm thick strips were prepared by extrusion-calendering. The extruder was of the AMUTO type (L/D=32, D=70 mm) and operated with a 220° C. flat temperature profile. The calender was of the AMUT® type, provided with 5 rolls, of which the respective temperatures (in ° C.) were 45/45/60/20/20.

The tubes were prepared on a Samafor tube extrusion line. The diameter of the tubes was 90 mm. The temperature profile used was the following: 170-200-210-230° C.

In order to characterize the materials, test pieces were cut out, either from the extruded strip or from the thickness of the extruded tube.

In order to carry out the fatigue tests, axisymmetric test pieces having a diameter of 4 mm were cut out from the circular thickness of the tube. These axisymmetric test pieces were then notched perpendicular to their axis with a notch radius of 4 mm.

For ductile-brittle transition temperature measurements, bars were made from the strip: length greater than 50 mm, width of 10 mm and thickness: that of the strip.

### Description of the Methods for Characterizing the Materials

### Ageing Test

This test was carried out by immersing the test pieces obtained from the compositions of tests 1 to 5 in water at pH 7, rendered inert with ultra-pure nitrogen to eliminate the traces of oxygen, at 140° C. in an autoclave, for several days, especially for 7 days.

### Ductile-Brittle Transition (DBT) Temperature Measurement

To measure the ductile-brittle transition (DBT) temperature, notched flexural failure tests were carried out following a protocol derived from the test of standard ISO 179 1 eA.

This protocol was adapted to be more severe than that of said standard, in the sense that the notch was created using a razor blade and therefore had a notch tip radius smaller than the value of 0.25 mm recommended in this standard. The thickness of the bars used was also larger than that of the bars recommended in the standard (6 or 7 mm typically, versus 4 mm). The test was carried out, on 10 bars, by division into 5° C. steps to frame the DBT. This corresponds to 50% brittle fracture. The impact speed used as a reference was 10 mm/min (according to the standards OMAE2007-26th International Conference on Offshore Mechanics and Arctic Engineering, San Diego, 10-15 Jun. 2007, DEPOS 19 in 2004, 13-15 Oct. 2004, Poitiers, Etude de la Transmission Ductile Fragile du Polyamide 11 Soumis à un Vieillissement Hydrolytique [Study of the ductile-brittle transmission of polyamide 11 subjected to hydrolytic ageing], Nicolas Amouroux et al., GFP2004).

The results obtained are given in Table 2 below.

TABLE 2

| Trial | DBT [° C.] |
|---|---|
| 1 | 12 |
| 2 | −14 |
| 3 | −21 |
| 4 | −10 |
| 5 | −10 |

The bars obtained from the compositions of tests 4 and 5, according to the invention, had a ductile-brittle transition temperature close to although slightly greater than that obtained with the bars prepared from the composition described in the document US 2003/0220449.

These compositions are also less expensive and easier to process than the composition described in document US 2003/0220449.

Composition 3 has, in particular, an advantage in terms of processability, cost and mechanical strength.

In FIG. 1, a schematic cross-sectional view of a flexible pipe intended for transporting oil or gas has been represented.

This pipe comprises at least one layer 1 obtained from a composition as described previously and comprising from 70 to 91% by weight of at least one polyamide, from 5 to 25% by weight of an elastomeric copolymer and from 4 to 20% by weight of a plasticizer, the polyamide and the elastomeric copolymer being as defined above.

This pipe comprises, in addition, at least a second layer 2 which may be formed from one or more metallic components. Conventionally, this second layer 2 is formed by an extruded metal strip wound in a helix.

This second layer 2 is intended to be in contact with the oil or gas transported. The layer 1 is placed around the second layer 2 so as to ensure impermeability.

In the embodiment represented in FIG. 1, the pipe also comprises a third layer 3 placed around the layer 1.

This third layer 3, which is preferably made of metal or made of a composite material, makes it possible to counteract the internal pressure of the oil or of the gas transported and to thus prevent too large a deformation of the pipe.

Around the third layer 3 of the pipe represented in FIG. 1, a fourth protective layer 4 is placed.

In other variants of pipes according to the invention, which are not represented in FIG. 1, the following structures could also be envisaged:
a pipe that might only be formed from the layer 1 and the second layer 2; and
a pipe that may comprise a layer 1, a second layer 2 and a fourth protective layer 4 placed around the layer 1.

Of course, for reasons of mechanical, thermal and/or chemical resistance, it is also possible to envisage producing pipes comprising several layers 1, several second layers 2, several third layers 3 and/or several fourth protective layers 4.

1. A flexible pipe for use in the exploitation of offshore oil and gas deposits having a composition comprising:
from 70 to 91% by weight of at least one semicrystalline polyamide having an average number of carbon atoms per nitrogen atom, denoted by Nc, greater than or equal to 7.5;
from 5 to 25% by weight of a polyolefin comprising an epoxy, anhydride or acid functional group, introduced by grafting or by copolymerization; and
from 4 to 20% by weight of a plasticizer.

2. The flexible pipe according to claim 1, wherein the semicrystalline polyimide is chosen from PA-11, PA-12, aliphatic polyamides resulting from the condensation of an aliphatic diamine having from 6 to 12 carbon atoms and an aliphatic diacid having from 9 to 12 carbon atoms, copolyamides PA-11/12 having either more than 90% of PA-11 units or more than 90% of PA-12 units and polyphthalamides.

3. The flexible pipe according to claim 1, wherein the polyolefin is an elastomeric ethylene copolymer, preferably chosen from an ethylene/propylene copolymer (EPR), an ethylene/butylene copolymer and an ethylene/alkyl(meth)acrylate copolymer.

4. The flexible pipe according to claim 1, wherein the plasticizer is N-butylbenzenesulphonamide (BBSA).

5. The flexible pipe according to claim 1, wherein the polyamide contains a catalyst.

6. The flexible pipe according to claim 5, wherein the amount of catalyst is up to 3000 ppm, relative to the amount of polyamide.

7. The flexible pipe according to claim 1, wherein the composition comprises, in addition, at least one additive chosen from impact modifiers, dyes, pigments, brighteners, antioxidants and UV stabilizers.

8. The flexible pipe according to claim 1 wherein said polyolefin comprising an epoxy, anhydride or acid functional group, introduced by grafting or by copolymerization, is an elastomeric ethylene copolymer chosen from an ethylene/propylene copolymer (EPR), an ethylene/butylene copolymer and an ethylene/alkyl(meth)acrylate copolymer.

9. (canceled)

10. The flexible pipe according to claim 1, further comprising at least a second layer (2) formed from one or more metallic components, the second layer (2) being in contact with the oil or gas transported, the layer (1) being placed around the second layer (2) so as to ensure impermeability.

11. The flexible pipe according to claim 1, further comprising at least a third layer (3) made of metal or made of a composite material, the third layer (3) being placed around the layer (1) so as to counteract the internal pressure of the oil or of the gas transported.

12. The flexible pipe according to claim 1, further comprising at least a fourth protective layer (4) placed around the layer (1) or, if necessary, around the third layer (3).

13. The flexible pipe according to claim 1 having a composition comprising:
from 75 to 87% by weight, of at least one semicrystalline polyamide having an average number of carbon atoms per nitrogen atom, denoted by Nc, between 9 and 18;
from 8 to 15% by weight, of a polyolefin comprising an epoxy, anhydride or acid functional group, introduced by grafting or by copolymerization; and
from 5 to 13% by weight, of a plasticizer.

14. The flexible pipe according to claim 13 having a composition comprising
from 75 to 87% by weight, of at least one semicrystalline polyamide having an average number of carbon atoms per nitrogen atom, denoted by Nc, between 10 and 18;
from 8 to 12% by weight, of a polyolefin comprising an epoxy, anhydride or acid functional group, introduced by grafting or by copolymerization; and
from 5 to 13% by weight, of a plasticizer.

15. The flexible pipe of claim 5, wherein said catalyst is selected from phosphoric acid and hypophosphoric acid.

16. The flexible pipe according to claim 6, wherein the amount of catalyst is between 50 and 1000 ppm, relative to the amount of polyamide.
